(19) United States
(12) Patent Application Publication
(10) Pub. No.: US 2026/0288344 A1
(43) Pub. Date: Sep. 24, 2026

(54) MEMORY SYSTEM REPORTING OF DATA ACCESS FREQUENCY STATISTICS

(71) Applicant: Micron Technology, Inc., Boise, ID (US)

(72) Inventor: David Aaron Palmer, Boise, ID (US)

(21) Appl. No.: 19/559,480

(22) Filed: Mar. 6, 2026

Related U.S. Application Data
(60) Provisional application No. 63/773,932, filed on Mar. 18, 2025.

(51) Int. Cl. G06F 3/06

(52) U.S. Cl. CPC G06F 3/0616; G06F 3/0653; G06F 3/0659; G06F 3/0679

(57) ABSTRACT

Methods, systems, and devices for memory system reporting of data access frequency statistics are described. A host system may output a request to the memory system for access frequency information for a set of data. The memory system or the host system may generate access frequency labels for the set of data using one or more metrics indicative of the access frequency for the set of data and available to the memory system. In some examples, the memory system may output one or more measurements to the host system, and the host system may generate the access frequency labels in accordance with the one or more measurements. In some examples, the memory system may generate the access frequency labels. The memory system may output the one or more access frequency labels to the host system, or the memory system may store the one or more access frequency labels in metadata.

### CROSS REFERENCE

The present Application for Patent claims priority to U.S. Patent Application No. 63/773,932 by Palmer, entitled “MEMORY SYSTEM REPORTING OF DATA ACCESS FREQUENCY STATISTICS,” filed Mar. 18, 2025, which is assigned to the assignee hereof, and which is expressly incorporated by reference in its entirety herein.

### TECHNICAL FIELD

The following relates to one or more systems for memory, including memory system reporting of data access frequency statistics.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports memory system reporting of data access frequency statistics in accordance with examples as disclosed herein.

FIG. 2 shows an example of a flow diagram that supports memory system reporting of data access frequency statistics in accordance with examples as disclosed herein.

FIG. 3 shows an example block diagram of a memory system that supports memory system reporting of data access frequency statistics in accordance with examples as disclosed herein.

FIG. 4 shows an example flowchart illustrating a method or methods that support memory system reporting of data access frequency statistics in accordance with examples as disclosed herein.

### DETAILED DESCRIPTION

A memory system may store data that is accessed with a similar access frequency together (e.g., in a same range of addresses within the memory system, in a same zone of a memory system, in a same group of memory cells) to improve access efficiency, among other examples. The access frequency may be referred to as a temperature of the data in some examples herein (e.g., data accessed relatively frequently may be referred to as “hot” data and data accessed relatively infrequently may be referred to as “cold” data, in some examples). For example, the memory system may store data with an access frequency above an access frequency threshold (e.g., hot data or warm data) at a first set of addresses within the memory system (e.g., physical addresses), and the memory system may store data with an access frequency below an access frequency threshold (e.g., cold data) at a second set of addresses within the memory system. Keeping data with a similar access frequency (e.g., same-temperature data) together may enable the memory system to more accurately distribute wear across memory cells in the memory system, which may increase the longevity of the memory system among other examples. For example, the memory system may move stable data (e.g., lower access frequency data) in blocks that are relatively overworn to reduce further wear on such blocks overtime, and may move relatively high access frequency data to relatively less worn blocks to distribute overall wear and increase the longevity of the memory system, among other examples.

The memory system may store access frequency labels (e.g., temperature labels) for the data stored in the memory system. A host system (e.g., an administrator, user, or applications of the host system) may provide the access frequency labels to the memory system. For example, the host system may estimate or predict how frequently data may be accessed and the host system may indicate the access frequency labels via a write command for the data. In some examples, however, the host system may not accurately categorize (e.g., label) data, or heuristics used by the host system may not reflect behaviors of an individual user, among other examples. That is, in some examples, access frequency labels may be misleading or incorrect, such that the memory system may store data with varying access frequencies together due to inaccurate frequency labels, thereby decreasing the benefits of storing data with similar access frequencies together.

According to techniques described herein, the memory system may report access frequency metrics to the host system to improve access frequency labeling and data storage. For example, the host system may output a request to the memory system for access frequency information (e.g., temperature information) for a set of data. The memory system, the host system, or both may generate updated access frequency labels for the set of data using one or more metrics available to the memory system. For example, the memory system may measure one or more metrics (e.g., access frequency statistics) indicative of the access frequency for the set of data. In some examples, the memory system may output the one or more metrics to the host system, and the host system may generate the access frequency labels (e.g., temperature labels) in accordance with the one or more metrics. Additionally, or alternatively, the memory system may generate the access frequency labels and the memory system may output the access frequency labels to the host system, or the memory system may store the one or more access frequency labels as metadata within the memory system, or both. The access frequency labels generated at the host system or the memory system may more accurately categorize the access frequency (e.g., temperature) of data than the initial access frequency labels generated by the host system and provided at the time the data is written, which may enable the memory system to more accurately group and store data with a similar access frequency (e.g., same-temperature data) together or within the same set of addresses to improve access efficiency and a lifetime of the memory system, among other examples.

In addition to applicability in memory systems as described herein, techniques for memory system reporting of data access frequency statistics may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by more accurately storing data with a higher access frequency in a cache of the memory system, which may decrease processing or latency times, improve response times, or otherwise improve user experience, among other benefits.

In addition to applicability in memory systems as described herein, techniques for memory system reporting of data access frequency statistics may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by storing data with a lower access frequency in over-worn blocks, which may extend the life of electronic devices and thereby reducing electronic waste, among other benefits.

Features of the disclosure are illustrated and described in the context of systems, devices, and circuits. Features of the disclosure are further illustrated and described in the context of system, a flow diagrams, and flowcharts.

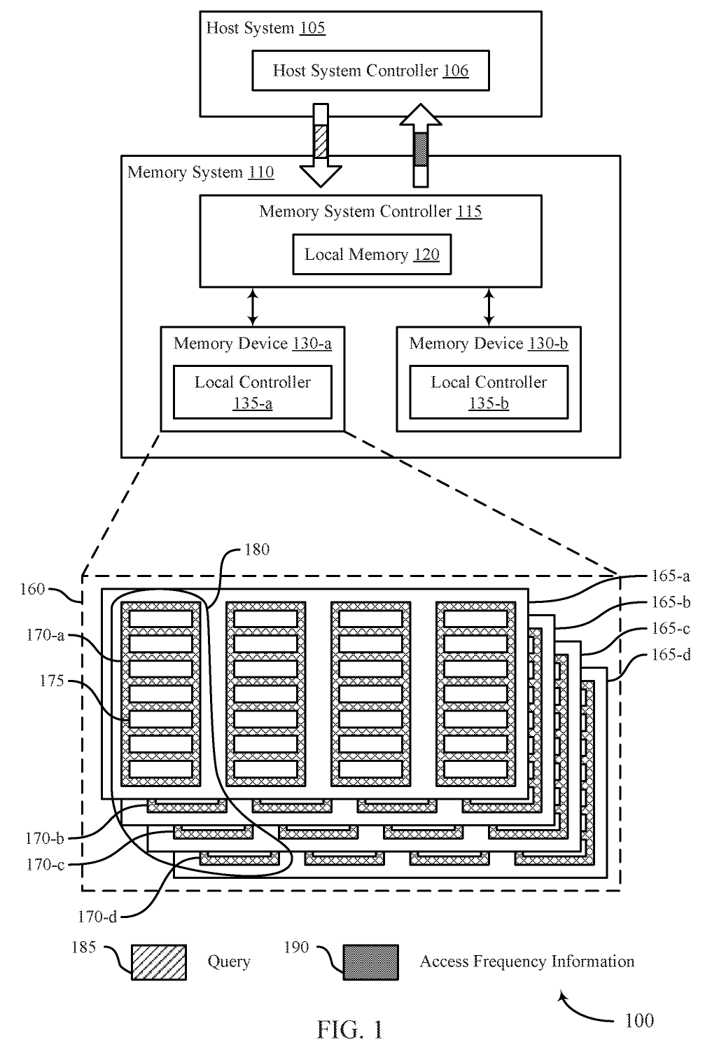

FIG. 1 shows an example of a system 100 that supports memory system reporting of data access frequency statistics in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The memory system 110 (e.g., a NAND based storage device) may benefit from storing same access frequency (e.g., same-temperature) data together (e.g., in a same data block, data partition, or set of addresses). For example, the memory system 110 may store a first set of data associated with a first access frequency (e.g., temperature) in a first set of addresses associated with the first access frequency, and the memory system 110 may store a second set of data associated with a second access frequency in a second set of addresses associated with the second access frequency.

In some examples, storing the data with a similar access frequency together may improve static wear leveling by storing stable data (e.g., cold data, data accessed relatively infrequently) in relatively over-worn data blocks of the memory system 110 to reduce further wear on such data blocks. In some examples, garbage collection may be improved by storing high access frequency data (e.g., hot data) in data blocks likely to end up invalidated, which may reduce a quantity of write operations performed by the memory system 110 (e.g., reducing write amplification). In some examples, a cache management component of the memory system 110 may store high access frequency data in one or more caches for a longer duration (e.g., so the high access frequency data may be overwritten), which may reduce a quantity of write operations performed by the memory system 110, among other examples.

The host system 105 may sort data by access frequency to help store data with similar access frequencies (e.g., same-temperature data) together. For example, the host system 105 may output a write command for a set of data including an indication of an access frequency label for the set of data. Some memory systems may operate according to a zoned UFS (zUFS) protocol, in which the memory system may segregate data into different zones in accordance with one or more metrics, including sorting zones by access frequency (e.g., temperature), which may improve garbage collection and zone un-mapping efficiency. In some examples, data stream separation may tag data with an access frequency label (e.g., temperature information) for improved data management (e.g., to store same-temperature data together).

In some cases, the host system 105 may not accurately classify a data access frequency. For example, the host system 105 may indicate inaccurate access frequency labels for a set of data. In some examples, applications of the host system 105 may not provide access frequency labels for data, and the host system 105 may apply one or more heuristics to estimate the access frequency labels. The host heuristics may not reflect behaviors (e.g., preferences) of an individual user. For example, the host heuristics may provide inaccurate guesses or predictions for the access frequency labels. Additionally, or alternatively, the applications or users of the host system 105 may provide inaccurate access frequency labels for data. For example, an application of the host system 105 may indicate that data associated with the application is hot data (e.g., data with a higher access frequency) even if some or all of the data is cold data (e.g., data with a lower access frequency).

According to techniques described herein, the host system 105 and the memory system 110 may update access frequency labels in accordance with access frequency metrics measured by the memory system 110. For example, the host system 105 may support an extended host interface, which may enable the host system 105 to query the memory system 110 for access frequency information (e.g., data temperature information). For example, the host system 105 may output a query 185 for access frequency information for a set of data that was previously written to the memory system 110. The memory system 110 may output the access frequency information 190 in response to the query 185. The query 185 may request information for a physical domain partition (e.g., virtual block or group of page lines) or logical domain partition (e.g., logical unit number (LUN) or LBA range). The memory system 110 may estimate or obtain the access frequency information 190 (e.g., the access frequency labels or metrics indicative of the access frequency labels) requested by the host system 105 using flash translation layer (FTL) information.

For example, the memory system 110 may measure one or more metrics indicative of the access frequency information 190 for a requested data partition. The metrics may be, for example, a valid data count, a quantity of L2P records which map valid data, a block family error avoidance (BFEA) bin for the data, a version number of the data, a percentage of the data that is sequential, one or more other metrics, or any combination thereof. The memory system 110 or the host system 105 may determine access frequency labels for the data partition in accordance with the measurements. In some examples, the memory system 110 may output, via the access frequency information 190, one or more measurements (e.g., access frequency statistics) corresponding to the one or more metrics, and the host system 105 may determine the access frequency labels in accordance with the one or more measurements. In some examples, the memory system 110 may determine access frequency labels for the data partition, and the access frequency information 190 may include the access frequency labels.

For managed garbage collection within the memory system, the expanded interface may enable the host system 105 to relabel access frequency labels (e.g., perform temperature relabeling) in a zone, a physical domain, a LUN, or an LBA range as garbage collection is triggered.

The system 100 may include any quantity of non-transitory computer readable media that support memory system reporting of data access frequency statistics. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

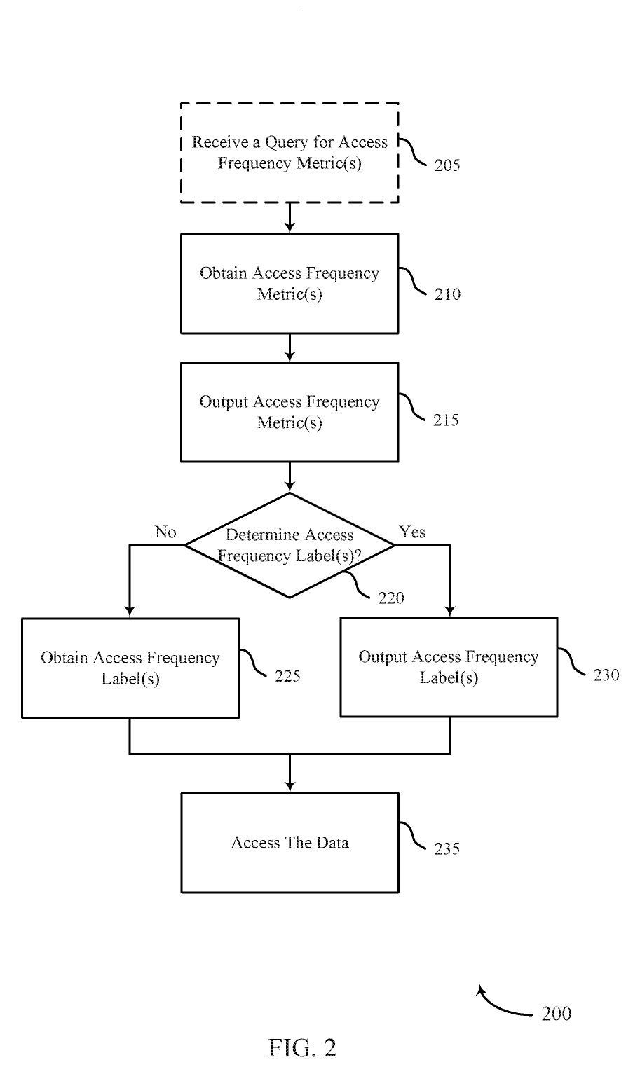

FIG. 2 shows an example of a flow diagram 200 that supports memory system reporting of data access frequency statistics in accordance with examples as disclosed herein. Aspects of the flow diagram 200 may implement or be implemented by aspects of the system 100. For example, the memory system 110, via the memory system controller 115 or a local controller 135, may perform the operations of the flow diagram 200. The techniques described in the context of the flow diagram 200 may enable the memory system 110 to obtain one or more metrics indicative of an access frequency for a set of data (e.g., a temperature of the set of data).

Aspects of the flow diagram 200 may be implemented by one or more controllers, among other components. Additionally, or alternatively, aspects of the flow diagram 200 may be implemented as instructions stored in one or more memories (e.g., firmware stored in one or more memories coupled with a memory system). For example, the instructions, when executed by one or more controllers (e.g., a memory system controller or a local controller), may cause the one or more controllers (or a device or a system) to perform the operations of the flow diagram 200.

Although shown in a particular sequence or order, unless otherwise specified, the order of the processes may be modified. Thus, the illustrated examples are used as examples, and the illustrated processes may be performed in a different order, and some processes may be performed in parallel. Additionally, one or more processes may be omitted in various examples. Thus, not all processes are used in every example. Other flows are possible.

In some cases, at 205, a query may be received. For example, the memory system 110 may receive the query (e.g., the query 185 as described with reference to FIG. 1) for access frequency information (e.g., the access frequency information 190 as described with reference to FIG. 1) associated with data stored in the memory system 110. A host system 105 may transmit the query to the memory system 110. The query may indicate one or more addresses associated with the data.

At 210, a set of access frequency metrics may be obtained. For example, the memory system 110 may obtain, in response to the query, the set of access frequency metrics associated with the data indicated via the query. The set of access frequency metrics may be indicative of an access frequency of the data. The set of access frequency metrics may include metrics associated with an age of the data, a type of the data, the access frequency of the data, a validity of the data, or any combination thereof.

The set of access frequency metrics may, in some examples, include a valid data count or percentage of valid data in the requested data partition. A higher valid data count or percentage may indicate less of the data in the data partition has been overwritten (e.g., indicating colder data). A lower valid data count or percentage may indicate more of the data in data partition has been overwritten (e.g., indicating hotter data).

Additionally, or alternatively, the set of access frequency metrics may include a quantity of L2P records that map the valid data in a physical domain. Fewer records may indicate that data in the data partition is more sequential data. Sequential data may indicate that more data written together is still valid (e.g., indicating colder data).

Additionally, or alternatively, the set of access frequency metrics may include an age of data in the requested partition. A younger age may indicate that the data may be associated with a higher data access frequency (e.g., hot data), while an older age may indicate that the data may be associated with a lower data access frequency (e.g., cold data). The age of the data may be represented by a BFEA bin of the data (e.g., that includes the data), a virtual block (VB) version number of the data, or both.

Additionally, or alternatively, the set of access frequency metrics may include a relatively percentage or amount of sequential data included in the requested partition. Data that is relatively more sequential may be associated with less frequent accesses, and data that is relatively more random may be associated with more frequent accesses.

At 215, an indication of the set of access frequency metrics may be output. For example, the memory system 110 may output, in response to the query, the indication of the set of access frequency metrics to the host system.

At 220, it may be determined whether the access frequency labels should be determined. For example, the memory system 110 may determine whether to use the access frequency metrics to generate updated access frequency labels at the memory system 110 or whether to wait for updated access frequency labels from the host system 105.

At 225, one or more access frequency labels may be obtained in response to determining to refrain from updating the access frequency labels. For example, the memory system 110 may refrain from updating the access frequency labels internally, and may instead wait and receive one or more access commands from the host system 105 that indicate the one or more access frequency labels in accordance with the indication of the set of access frequency metrics. For example, the access commands may rewrite the data to a new zone (e.g., in a zoned architecture), or the access commands may initiate garbage collection to update the access frequency labels. Such accesses may be associated with categorizing, or reordering the data according to access frequency, in some examples.

At 230, the access frequency labels may be updated in response to determining to update the access frequency labels. For example, the memory system 110 may determine new (e.g., updated, more accurate) access frequency labels for the data in accordance with the access frequency metrics measured at 210. The memory system 110 may thereby determine that one or more access frequency labels for the data may benefit from an update, and the memory system may determine (e.g., calculate, measure, estimate, generate) the updated access frequency labels accordingly, which may be referred to as categorizing or reorganizing the data according to access frequency, in some examples. In some examples, the memory system 110 may output the access frequency labels to the host system 105 so that the host system 105 is able to identify the updated labels. In some cases, the memory system 110 may determine to perform access frequency relabeling without receiving the query from the host system 105.

Once or more labels of access frequency for at least some of the data may thereby be updated by the host system 105, the memory system 110, or both in response to the query and in accordance with the access frequency metrics. Updating the access frequency labels may include storing the updated access frequency labels as metadata associated with the data, among other examples.

The host system 105 or the memory system 110, or both may determine updated (e.g., accurate) access frequency labels for the data in accordance with the access frequency metrics, including the valid data count. For example, the memory system 110 may determine a percentage of the data that is valid. A validity of the data may be in accordance with the percentage of the data that is valid. A first percentage of valid data may indicate a first access frequency associated with a first access frequency label for the data, and a second percentage of valid data that is greater than the first percentage may indicate a second access frequency that is lower than the first access frequency and may be associated with a second access frequency label for the data.

The host system 105 or the memory system 110, or both may determine updated access frequency labels for the data in accordance with the access frequency metrics, including a quantity of L2P records that map the valid data in the physical domain. For example, the memory system 110 may determine a quantity of entries in a L2P mapping table. A type of the data may be in accordance with the quantity of entries. A first range of quantities of entries in the L2P mapping table may indicate a first access frequency associated with a first access frequency label for the data, and a second range of quantities of entries in the logical-to-physical mapping table that is less than the first range of quantities may indicate a second access frequency that is lower than the first access frequency and may be associated with a second access frequency label for the data.

The host system 105 or the memory system 110, or both may determine updated access frequency labels for the data in accordance with the access frequency metrics, including age of data in the data partition. A younger data age may indicate that the data may be associated with a higher data access frequency (e.g., hot data), while an older age may indicate that the data may be associated with a lower data access frequency (e.g., cold data). In some cases, the host system 105 or the memory system 110 may estimate the age of the data in the data partition in accordance with BFEA bin information. For example, the host system 105 or the memory system 110 may estimate the age of the data in wall clock time.

For example, the memory system 110 may determine a BFEA bin associated with the data. A first BFEA bin associated with a first data age may indicate a first access frequency associated with a first access frequency label for the data, and a second BFEA bin associated with a second data age that is older than the first data age may indicate a second access frequency that is lower than the first access frequency and may be associated with a second access frequency label for the data.

In some cases, the host system 105 or the memory system 110 may estimate the age of the data relative to currently open VBs or other VBs in the device. For example, the memory system 110 may determine a version number associated with the data. A first set of version numbers associated with a first data age may indicate a first access frequency associated with a first access frequency label for the data, and a second set of version numbers associated with a second data age that is older than the first data age may indicate a second access frequency that is lower than the first access frequency and may be associated with a second access frequency label for the data.

The host system 105 or the memory system 110, or both may determine updated (e.g., accurate) access frequency labels for the data in accordance with the access frequency metrics, including a relative amount of sequential data in the data portion. For example, the host system 105 or the memory system 110 may determine sequential data (e.g., generally cooler data) or random data (e.g., generally hotter data) composition statistics and an average length of sequential data (e.g., a larger length may indicate cooler data).

At 235, after the adjusted access frequency labels are generated and/or obtained, the data may be accessed (e.g., re-ordered, categorized, moved) in accordance with the adjusted access frequency labels. For example, the memory system 110 may receive the one or more access commands with the updated access frequency labels and may perform a corresponding access operation (e.g., rewrite, garbage collect, move, erase, or the like) on the data in accordance with the access commands. The updated access frequency labels may be stored with the data as part of the access operation, in some examples. Additionally, or alternatively, if the memory system 110 determines the updated access frequency labels, the memory system 110 may initiate a garbage collection operation associated with garbage collecting at least a portion of the data in order to rewire the data to new addresses associated with the updated access frequency labels.

In some examples, the data may be rewritten. For example, the memory system 110 may rewrite, in accordance with the one or more access commands, the data from the one or more addresses to one or more second addresses in accordance with the one or more access frequency labels. The one or more access commands may include a request for the memory system to rewrite the data to a new location in accordance with the one or more access frequency labels.

In an illustrative example, the host system 105 (e.g., a zUFS host) may decide to rewrite the data currently stored in a zone (e.g., zone X) within the memory system 110. The data in the zone X may have previously been classified by the host system 105 with a first access frequency label (e.g., as warm) on write in accordance with an application hint or a guess. The host system 105 may query the memory system 110 (e.g., storage device) for access frequency statistics for the zone X. The memory system 110 may return the access frequency information indicating that the data is mostly valid, mostly sequential, and older than most data on the drive, which may indicate that the data is accessed relatively infrequently. The host system 105 may read the valid data from the zone and rewrite the valid data using a second access frequency label (e.g., a cold temperature tag instead of a warm temperature tag).

In some examples, garbage collection may be performed. For example, the memory system 110 may perform, in accordance with the one or more access commands, garbage collection associated with at least a portion of the data. The one or more access commands may include a request for the memory system to perform the garbage collection. For example, the memory system 110 may performing garbage collection in accordance with the one or more access frequency labels. The garbage collection may be associated with a rewrite of the data from the one or more addresses associated to one or more second addresses associated with the one or more access frequency labels.

In an illustrative example, the host system 105 may initiate garbage collection for some memory device 145 (e.g., LUN). As described herein, the data in the memory device 145 may have previously been classified by the host system 105 with a first access frequency label (e.g., as warm) on write in accordance with an application hint or a guess. The host system 105 may query the memory system 110 (e.g., storage device) for access frequency statistics for the memory device 145. The memory system 110 may return access frequency information indicating that the data is mostly valid, mostly sequential, and older than most data on the drive, which may indicate that the data is accessed relatively infrequently. The host system 105 may initiate garbage collection on the memory system 110 (e.g., for some memory device 145).

After initiating garbage collection, the host system 105 may indicate that the data should be tagged with a second access frequency label (e.g., cold) instead of the first access frequency label (e.g., warm). One or more access commands for host initiated garbage collection may include a parameter (e.g., option) for access frequency labels or access frequency information of the data indicated for garbage collection by the one or more access commands. The host system may indicate an option Host Initiated GC parameter / option.

In some cases, metadata may be stored. For example, the memory system 110 may store, to the memory system 110, the metadata that may indicate the one or more access frequency labels in accordance with the determining at 225. The memory system 110 may store the metadata without receiving a query for the access frequency metrics at 205.

The improved data access frequency classification described herein may increase accuracy during garbage collection. For example, garbage collected or rewritten data includes access frequency labels (e.g., temperature tags) updated to reflect real data behavior (e.g., indicated by the metrics measured by the memory system 110).

The more accurate access frequency labels may increase the effectiveness and efficiency of operations performed by host system 105 and the memory system 110 for access frequency aware data (e.g., temperature aware data). For example, the host system 105 and the memory system 110 may perform data access frequency separation (e.g., hot or cold data separation), static wear leveling, garbage collection, and cache management more efficiently. Additionally, device lifetime, performance, and user experience may be improved in accordance with the more accurate access frequency labels.

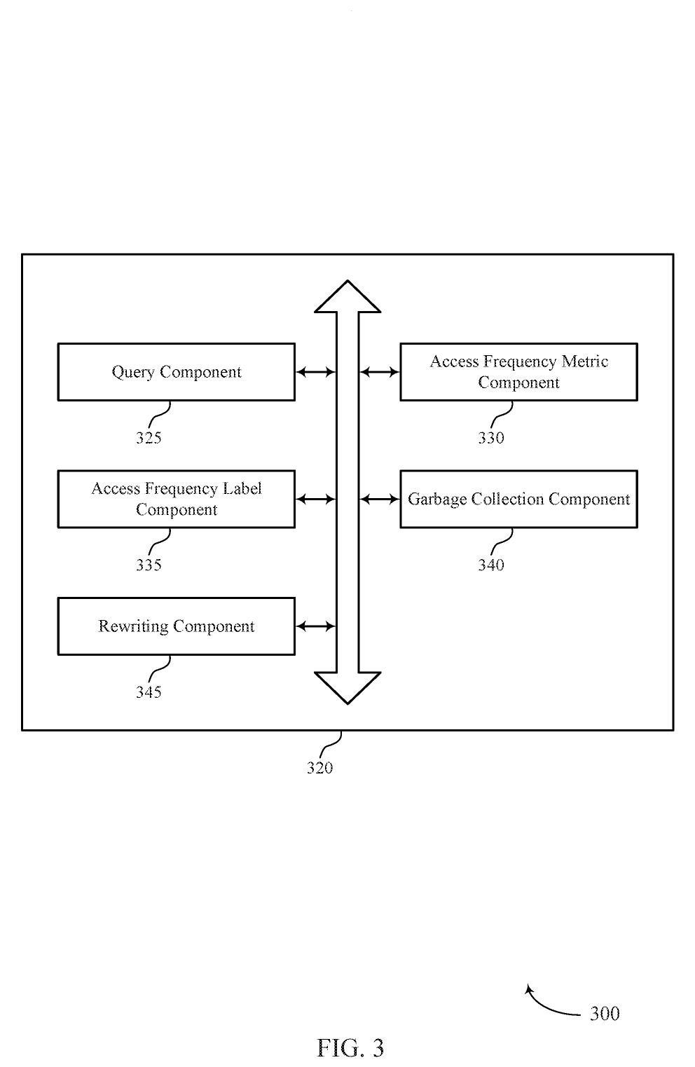

FIG. 3 shows a block diagram 300 of a memory system 320 that supports memory system reporting of data access frequency statistics in accordance with examples as disclosed herein. The memory system 320 may be an example of aspects of a memory system as described with reference to FIGS. 1-3. The memory system 320, or various components thereof, may be an example of means for performing various aspects of memory system reporting of data access frequency statistics as described herein. For example, the memory system 320 may include a query component 325, an access frequency metric component 330, an access frequency label component 335, a garbage collection component 340, a rewriting component 345, or any combination thereof. Each of these components, or components of subcomponents thereof (e.g., one or more processors, one or more memories), may communicate, directly or indirectly, with one another (e.g., via one or more buses).

The query component 325 may be configured as or otherwise support a means for receiving a query for access frequency information associated with data stored in the memory system, where the query indicates one or more addresses associated with the data. The access frequency metric component 330 may be configured as or otherwise support a means for obtaining, in response to the query, a plurality of access frequency metrics associated with the data indicated via the query, where the plurality of access frequency metrics is indicative of an access frequency of the data. The access frequency label component 335 may be configured as or otherwise support a means for accessing the data in accordance with one or more access frequency labels associated with the data, the one or more access frequency labels determined in accordance with the plurality of access frequency metrics.

In some examples, the access frequency metric component 330 may be configured as or otherwise support a means for outputting, in response to the query, an indication of the plurality of access frequency metrics. In some examples, the access frequency label component 335 may be configured as or otherwise support a means for obtaining one or more access commands that indicate the one or more access frequency labels in accordance with the indication of the plurality of access frequency metrics, where accessing the data is in accordance with the one or more access commands.

In some examples, to support accessing the data, the rewriting component 345 may be configured as or otherwise support a means for rewriting, in accordance with the one or more access commands, the data from the one or more addresses to one or more second addresses in accordance with the one or more access frequency labels, where the one or more access commands include a request for the memory system to rewrite the data to a new location in accordance with the one or more access frequency labels.

In some examples, to support accessing the data, the garbage collection component 340 may be configured as or otherwise support a means for performing, in accordance with the one or more access commands, garbage collection associated with at least a portion of the data, where the one or more access commands include a request for the memory system to perform the garbage collection.

In some examples, the access frequency label component 335 may be configured as or otherwise support a means for determining the one or more access frequency labels in accordance with the plurality of access frequency metrics. In some examples, the access frequency label component 335 may be configured as or otherwise support a means for storing, to the memory system, metadata that indicates the one or more access frequency labels in accordance with the determining.

In some examples, the access frequency label component 335 may be configured as or otherwise support a means for determining the one or more access frequency labels in accordance with the plurality of access frequency metrics. In some examples, the access frequency label component 335 may be configured as or otherwise support a means for outputting, in response to the query, an indication of the one or more access frequency labels determined in accordance with the plurality of access frequency metrics.

In some examples, to support accessing the data, the garbage collection component 340 may be configured as or otherwise support a means for performing garbage collection in accordance with the one or more access frequency labels, where the garbage collection is associated with a rewrite of the data from the one or more addresses associated to one or more second addresses associated with the one or more access frequency labels.

In some examples, the plurality of access frequency metrics includes metrics associated with an age of the data, a type of the data, the access frequency of the data, a validity of the data, or any combination thereof.

In some examples, to support obtaining the plurality of access frequency metrics, the access frequency metric component 330 may be configured as or otherwise support a means for determining a percentage of the data that is valid, where a validity of the data is in accordance with the percentage of the data that is valid, and where a first percentage of valid data indicates a first access frequency associated with a first access frequency label for the data, and a second percentage of valid data that is greater than the first percentage indicates a second access frequency that is lower than the first access frequency and is associated with a second access frequency label for the data.

In some examples, to support obtaining the plurality of access frequency metrics, the access frequency metric component 330 may be configured as or otherwise support a means for determining a quantity of entries in a L2P table, where a type of the data is in accordance with the quantity of entries, and where a first range of quantities of entries in the L2P table indicates a first access frequency associated with a first access frequency label for the data, and a second range of quantities of entries in the L2P table that is less than the first range of quantities indicates a second access frequency that is lower than the first access frequency and is associated with a second access frequency label for the data.

In some examples, to support obtaining the plurality of access frequency metrics, the access frequency metric component 330 may be configured as or otherwise support a means for determining a BFEA bin associated with the data, where an age of the data is in accordance with the BFEA bin, and where a first BFEA bin associated with a first data age indicates a first access frequency associated with a first access frequency label for the data, and a second BFEA bin associated with a second data age that is older than the first data age indicates a second access frequency that is lower than the first access frequency and is associated with a second access frequency label for the data.

In some examples, to support obtaining the plurality of access frequency metrics, the access frequency metric component 330 may be configured as or otherwise support a means for determining a version number associated with the data, where an age of the data is in accordance with the version number, and where a first set of version numbers associated with a first data age indicates a first access frequency associated with a first access frequency label for the data, and a second set of version numbers associated with a second data age that is older than the first data age indicates a second access frequency that is lower than the first access frequency and is associated with a second access frequency label for the data.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

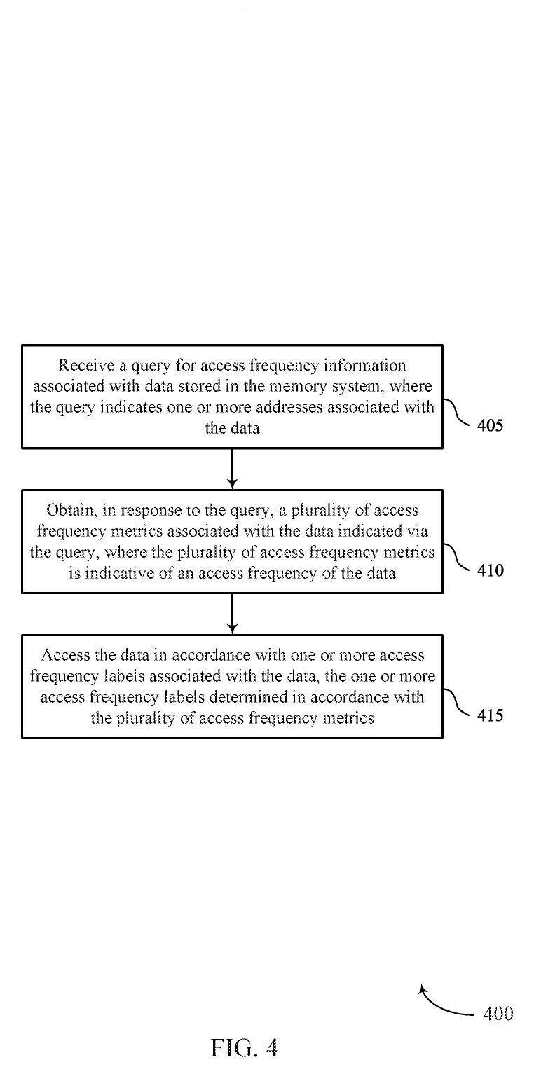

FIG. 4 shows a flowchart illustrating a method 400 that supports memory system reporting of data access frequency statistics in accordance with examples as disclosed herein. The operations of method 400 may be implemented by a memory system or its components as described herein. For example, the operations of method 400 may be performed by a memory system as described with reference to FIGS. 1-3. In some examples, a memory system may execute a set of instructions to control the functional elements of the device to perform the described functions. Additionally, or alternatively, the memory system may perform aspects of the described functions using special-purpose hardware.

At 405, the method may include receiving a query for access frequency information associated with data stored in the memory system, where the query indicates one or more addresses associated with the data. In some examples, aspects of the operations of 405 may be performed by a query component 325 as described with reference to FIG. 3.

At 410, the method may include obtaining, in response to the query, a plurality of access frequency metrics associated with the data indicated via the query, where the plurality of access frequency metrics is indicative of an access frequency of the data. In some examples, aspects of the operations of 410 may be performed by an access frequency metric component 330 as described with reference to FIG. 3.

At 415, the method may include accessing the data in accordance with one or more access frequency labels associated with the data, the one or more access frequency labels determined in accordance with the plurality of access frequency metrics. In some examples, aspects of the operations of 415 may be performed by an access frequency label component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a query for access frequency information associated with data stored in the memory system, where the query indicates one or more addresses associated with the data; obtaining, in response to the query, a plurality of access frequency metrics associated with the data indicated via the query, where the plurality of access frequency metrics is indicative of an access frequency of the data; and accessing the data in accordance with one or more access frequency labels associated with the data, the one or more access frequency labels determined in accordance with the plurality of access frequency metrics.

Aspect 2: The method, apparatus, or non-transitory computer-readable medium of aspect 1, further including operations, features, circuitry, logic, means, or instructions, or any combination thereof for outputting, in response to the query, an indication of the plurality of access frequency metrics and obtaining one or more access commands that indicate the one or more access frequency labels in accordance with the indication of the plurality of access frequency metrics, where accessing the data is in accordance with the one or more access commands.

Aspect 3: The method, apparatus, or non-transitory computer-readable medium of aspect 2, where accessing the data includes operations, features, circuitry, logic, means, or instructions, or any combination thereof for rewriting, in accordance with the one or more access commands, the data from the one or more addresses to one or more second addresses in accordance with the one or more access frequency labels, where the one or more access commands include a request for the memory system to rewrite the data to a new location in accordance with the one or more access frequency labels.

Aspect 4: The method, apparatus, or non-transitory computer-readable medium of any of aspects 2 through 3, where accessing the data includes operations, features, circuitry, logic, means, or instructions, or any combination thereof for performing, in accordance with the one or more access commands, garbage collection associated with at least a portion of the data, where the one or more access commands include a request for the memory system to perform the garbage collection.

Aspect 5: The method, apparatus, or non-transitory computer-readable medium of any of aspect 1, further including operations, features, circuitry, logic, means, or instructions, or any combination thereof for determining the one or more access frequency labels in accordance with the plurality of access frequency metrics and storing, to the memory system, metadata that indicates the one or more access frequency labels in accordance with determining the one or more access frequency labels.

Aspect 6: The method, apparatus, or non-transitory computer-readable medium of any of aspect 1, further including operations, features, circuitry, logic, means, or instructions, or any combination thereof for determining the one or more access frequency labels in accordance with the plurality of access frequency metrics and outputting, in response to the query, an indication of the one or more access frequency labels determined in accordance with the plurality of access frequency metrics.

Aspect 7: The method, apparatus, or non-transitory computer-readable medium of any of aspects 1 through 6, where accessing the data further includes operations, features, circuitry, logic, means, or instructions, or any combination thereof for performing garbage collection in accordance with the one or more access frequency labels, where the garbage collection is associated with a rewrite of the data from the one or more addresses associated to one or more second addresses associated with the one or more access frequency labels.

Aspect 8: The method, apparatus, or non-transitory computer-readable medium of any of aspects 1 through 7, where the plurality of access frequency metrics includes metrics associated with an age of the data, a type of the data, the access frequency of the data, a validity of the data, or any combination thereof.

Aspect 9: The method, apparatus, or non-transitory computer-readable medium of any of aspects 1 through 8, where obtaining the plurality of access frequency metrics includes operations, features, circuitry, logic, means, or instructions, or any combination thereof for determining a percentage of the data that is valid, where a validity of the data is in accordance with the percentage of the data that is valid, and where a first percentage of valid data indicates a first access frequency associated with a first access frequency label for the data, and a second percentage of valid data that is greater than the first percentage indicates a second access frequency that is lower than the first access frequency and is associated with a second access frequency label for the data.

Aspect 10: The method, apparatus, or non-transitory computer-readable medium of any of aspects 1 through 9, where obtaining the plurality of access frequency metrics includes operations, features, circuitry, logic, means, or instructions, or any combination thereof for determining a quantity of entries in a L2P table, where a type of the data is in accordance with the quantity of entries, and where a first range of quantities of entries in the L2P table indicates a first access frequency associated with a first access frequency label for the data, and a second range of quantities of entries in the L2P table that is less than the first range of quantities indicates a second access frequency that is lower than the first access frequency and is associated with a second access frequency label for the data.

Aspect 11: The method, apparatus, or non-transitory computer-readable medium of any of aspects 1 through 10, where obtaining the plurality of access frequency metrics includes operations, features, circuitry, logic, means, or instructions, or any combination thereof for determining a BFEA bin associated with the data, where an age of the data is in accordance with the BFEA bin, and where a first BFEA bin associated with a first data age indicates a first access frequency associated with a first access frequency label for the data, and a second BFEA bin associated with a second data age that is older than the first data age indicates a second access frequency that is lower than the first access frequency and is associated with a second access frequency label for the data.

Aspect 12: The method, apparatus, or non-transitory computer-readable medium of any of aspects 1 through 11, where obtaining the plurality of access frequency metrics includes operations, features, circuitry, logic, means, or instructions, or any combination thereof for determining a version number associated with the data, where an age of the data is in accordance with the version number, and where a first set of version numbers associated with a first data age indicates a first access frequency associated with a first access frequency label for the data, and a second set of version numbers associated with a second data age that is older than the first data age indicates a second access frequency that is lower than the first access frequency and is associated with a second access frequency label for the data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a query for access frequency information associated with data stored in the memory system, wherein the query indicates one or more addresses associated with the data;
obtain, in response to the query, a plurality of access frequency metrics associated with the data indicated via the query, wherein the plurality of access frequency metrics is indicative of an access frequency of the data; and
access the data in accordance with one or more access frequency labels associated with the data, the one or more access frequency labels determined in accordance with the plurality of access frequency metrics.

2. The memory system of claim 1, wherein the processing circuitry is further configured to cause the memory system to:
output, in response to the query, an indication of the plurality of access frequency metrics; and
obtain one or more access commands that indicate the one or more access frequency labels in accordance with the indication of the plurality of access frequency metrics, wherein accessing the data is in accordance with the one or more access commands.

3. The memory system of claim 2, wherein, to access the data, the processing circuitry is further configured to cause the memory system to:
rewrite, in accordance with the one or more access commands, the data from the one or more addresses to one or more second addresses in accordance with the one or more access frequency labels, wherein the one or more access commands comprise a request for the memory system to rewrite the data to a new location in accordance with the one or more access frequency labels.

4. The memory system of claim 2, wherein, to access the data, the processing circuitry is further configured to cause the memory system to:
perform, in accordance with the one or more access commands, garbage collection associated with at least a portion of the data, wherein the one or more access commands comprise a request for the memory system to perform the garbage collection.

5. The memory system of claim 1, wherein the processing circuitry is further configured to cause the memory system to:
determine the one or more access frequency labels in accordance with the plurality of access frequency metrics; and
store, to the memory system, metadata that indicates the one or more access frequency labels in accordance with determining the one or more access frequency labels.

6. The memory system of claim 1, wherein the processing circuitry is further configured to cause the memory system to:
determine the one or more access frequency labels in accordance with the plurality of access frequency metrics; and
output, in response to the query, an indication of the one or more access frequency labels determined in accordance with the plurality of access frequency metrics.

7. The memory system of claim 1, wherein, to access the data, the processing circuitry is further configured to cause the memory system to:
perform garbage collection in accordance with the one or more access frequency labels, wherein the garbage collection is associated with a rewrite of the data from the one or more addresses associated to one or more second addresses associated with the one or more access frequency labels.

8. The memory system of claim 1, wherein the plurality of access frequency metrics comprises metrics associated with an age of the data, a type of the data, the access frequency of the data, a validity of the data, or any combination thereof.

9. The memory system of claim 1, wherein, to obtain the plurality of access frequency metrics, the processing circuitry is further configured to cause the memory system to:
determine a percentage of the data that is valid, wherein a validity of the data is in accordance with the percentage of the data that is valid, and wherein:
a first percentage of valid data indicate a first access frequency associated with a first access frequency label for the data, and
a second percentage of valid data that be greater than the first percentage indicates a second access frequency that is lower than the first access frequency and is associated with a second access frequency label for the data.

10. The memory system of claim 1, wherein, to obtain the plurality of access frequency metrics, the processing circuitry is further configured to cause the memory system to:
determine a quantity of entries in a logical-to-physical mapping table, wherein a type of the data is in accordance with the quantity of entries, and wherein:
a first range of quantities of entries in the logical-to-physical mapping table indicate a first access frequency associated with a first access frequency label for the data, and
a second range of quantities of entries in the logical-to-physical mapping table that be less than the first range of quantities indicates a second access frequency that is lower than the first access frequency and is associated with a second access frequency label for the data.

11. The memory system of claim 1, wherein, to obtain the plurality of access frequency metrics, the processing circuitry is further configured to cause the memory system to:
determine a block error avoidance bin associated with the data, wherein an age of the data is in accordance with the block error avoidance bin, and wherein:
a first block error avoidance bin associated with a first data age indicates a first access frequency associated with a first access frequency label for the data, and
a second block error avoidance bin associated with a second data age that is older than the first data age indicates a second access frequency that is lower than the first access frequency and is associated with a second access frequency label for the data.

12. The memory system of claim 1, wherein, to obtain the plurality of access frequency metrics, the processing circuitry is further configured to cause the memory system to:
determine a version number associated with the data, wherein an age of the data is in accordance with the version number, and wherein:
a first set of version numbers associated with a first data age indicates a first access frequency associated with a first access frequency label for the data, and
a second set of version numbers associated with a second data age that is older than the first data age indicates a second access frequency that is lower than the first access frequency and is associated with a second access frequency label for the data.

13. A non-transitory computer-readable medium storing code comprising instructions which, when executed by processing circuitry of a memory system, cause the memory system to:
receive a query for access frequency information associated with data stored in the memory system, wherein the query indicates one or more addresses associated with the data;
obtain, in response to the query, a plurality of access frequency metrics associated with the data indicated via the query, wherein the plurality of access frequency metrics is indicative of an access frequency of the data; and
access the data in accordance with one or more access frequency labels associated with the data, the one or more access frequency labels determined in accordance with the plurality of access frequency metrics.

14. The non-transitory computer-readable medium of claim 13, wherein the instructions, when executed by the processing circuitry of the memory system, further cause the memory system to:
output, in response to the query, an indication of the plurality of access frequency metrics; and
obtain one or more access commands that indicate the one or more access frequency labels in accordance with the indication of the plurality of access frequency metrics, wherein accessing the data is in accordance with the one or more access commands.

15. The non-transitory computer-readable medium of claim 14, wherein the instructions to access the data, when executed by the processing circuitry of the memory system, further cause the memory system to:
rewrite, in accordance with the one or more access commands, the data from the one or more addresses to one or more second addresses in accordance with the one or more access frequency labels, wherein the one or more access commands comprise a request for the memory system to rewrite the data to a new location in accordance with the one or more access frequency labels.

16. The non-transitory computer-readable medium of claim 14, wherein the instructions to access the data, when executed by the processing circuitry of the memory system, further cause the memory system to:
perform, in accordance with the one or more access commands, garbage collection associated with at least a portion of the data, wherein the one or more access commands comprise a request for the memory system to perform the garbage collection.

17. The non-transitory computer-readable medium of claim 13, wherein the instructions, when executed by the processing circuitry of the memory system, further cause the memory system to:
determine the one or more access frequency labels in accordance with the plurality of access frequency metrics; and
store, to the memory system, metadata that indicates the one or more access frequency labels in accordance with determining the one or more access frequency labels.

18. The non-transitory computer-readable medium of claim 13, wherein the instructions, when executed by the processing circuitry of the memory system, further cause the memory system to:
determine the one or more access frequency labels in accordance with the plurality of access frequency metrics; and
output, in response to the query, an indication of the one or more access frequency labels determined in accordance with the plurality of access frequency metrics.

19. The non-transitory computer-readable medium of claim 13, wherein the instructions to access the data, when executed by the processing circuitry of the memory system, further cause the memory system to:
perform garbage collection in accordance with the one or more access frequency labels, wherein the garbage collection is associated with a rewrite of the data from the one or more addresses associated to one or more second addresses associated with the one or more access frequency labels.

20. The non-transitory computer-readable medium of claim 13, wherein the plurality of access frequency metrics comprises metrics associated with an age of the data, a type of the data, the access frequency of the data, a validity of the data, or any combination thereof.

21. A method by a memory system, comprising:
receiving a query for access frequency information associated with data stored in the memory system, wherein the query indicates one or more addresses associated with the data;
obtaining, in response to the query, a plurality of access frequency metrics associated with the data indicated via the query, wherein the plurality of access frequency metrics is indicative of an access frequency of the data; and
accessing the data in accordance with one or more access frequency labels associated with the data, the one or more access frequency labels determined in accordance with the plurality of access frequency metrics.

22. The method of claim 21, further comprising:
outputting, in response to the query, an indication of the plurality of access frequency metrics; and
obtaining one or more access commands that indicate the one or more access frequency labels in accordance with the indication of the plurality of access frequency metrics, wherein accessing the data is in accordance with the one or more access commands.
